(19) United States
(12) Patent Application Publication
(10) Pub. No.: US 2009/0151741 A1
(43) Pub. Date: Jun. 18, 2009

(54) A COSMETIC TEMPLATE AND METHOD FOR CREATING A COSMETIC TEMPLATE

(76) Inventor: Diem Ngo, Dallas, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/333,889

(22) Filed: Dec. 12, 2008

Related U.S. Application Data
(60) Provisional application No. 61/007,727, filed on Dec. 14, 2007.

(51) Int. Cl. A45D 40/30; A45D 40/26; G06T 11/20

(52) U.S. Cl. 132/216; 132/319; 132/320; 345/441

(57) ABSTRACT

A method for creating a customized cosmetic template, comprising disposing a transfer medium to an eyebrow region having cosmetics applied thereto, and transmitting an image of the eyebrow region to a computing device coupled to a shaping apparatus used to form the customized cosmetic template based on the image.

### CROSS-REFERENCE TO RELATED PATENT APPLICATIONS

This patent application claims the benefit of U.S. Provisional Patent Application No. 61/007,727, filed Dec. 14, 2007, the teachings and disclosure of which are hereby incorporated in their entireties by reference thereto.

### BACKGROUND OF THE INVENTION

Cosmetic templates are used to enable people to consistently apply cosmetics to specific facial regions. However, in general, only a standard set of cosmetic templates are available. Thus, the standard templates do not accommodate an individual's unique facial features (e.g., shape, size, etc.) and/or a preferred/desired shape, style, and pattern for the specific facial region.

### BRIEF DESCRIPTION OF THE SEVERAL VIEWS OF THE DRAWINGS

FIG. 1 illustrates an embodiment of a facial guide used to create a customized cosmetic template;

FIG. 2 illustrates an embodiment for creating an image of a facial region used to form a customized cosmetic template for the eyebrow region of FIG. 1;

FIGS. 3A through 3C illustrate another embodiment for creating an image of a facial region used to form a customized cosmetic template for the eyebrow region of FIG. 1;

FIGS. 4A through 4C illustrate an embodiment for creating a customized cosmetic template for the eyebrow region of FIG. 1;

FIG. 5 illustrates an embodiment of a customized cosmetic template system;

FIG. 6 is a block diagram of an embodiment of a customized cosmetic template system of FIG. 5;

FIG. 7 is a flowchart illustrating an embodiment of a method for creating a customized cosmetic template;

FIG. 8 is a flowchart illustrating another embodiment of a method for creating a customized cosmetic template; and

FIG. 9 is a flowchart illustrating another embodiment of a method for creating a customized cosmetic template.

### DETAILED DESCRIPTION OF THE INVENTION

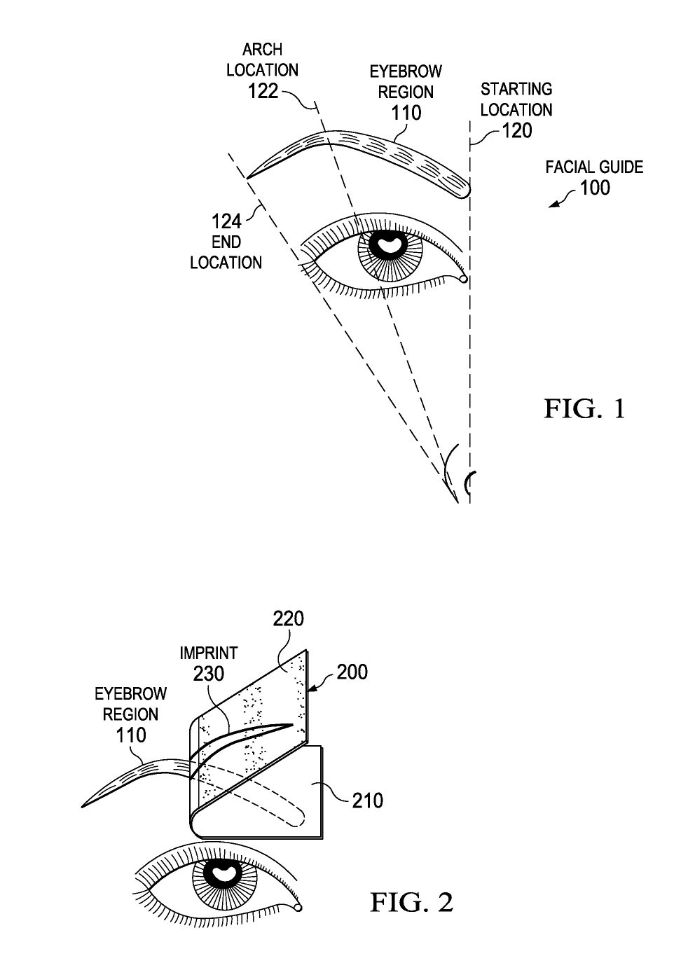

FIG. 1 illustrates an embodiment of a facial guide 100 used to create a customized cosmetic template. Facial guide 100 is a diagram illustrating an area on a client's face for which a customized cosmetic template will be created. For example, in FIG. 1, facial guide 100 is a diagram illustrating an eyebrow region 110 for which a customized cosmetic template will be created. However, it should be understood that, in alternative embodiments, facial guide 100 may illustrate other regions of the face for which a customized cosmetic template may be made (e.g., the cheeks, the lips, etc.).

In FIG. 1, facial guide 100 identifies three reference points for eyebrow region 110: a starting location 120, an arch location 122 and an end location 124. Each of locations 120, 122, and 124 identify a reference point for creating and/or designing the shape, style and/or pattern of eyebrow region 110 for a client. In FIG. 1, starting location 120 and end location 124 identify the respective beginning and end of eyebrow region 110. Arch location 122 identifies the location where the shape of eyebrow region 110 peaks relative to starting location 120 and end location 124.

FIG. 1 illustrates an example embodiment of a shape, style, and/or pattern for eyebrow region 110 for a client. However, it should be understood that eyebrow region 110 can be customized for a client using other preferred shapes, styles, and/or patterns for eyebrow region 110 using locations 120, 122, and 124 on the client's face as reference points. In some embodiments, eyebrow region 110 is physically shaped and/or styled by using one or more cosmetic salon methods and/or devices (e.g., tweezing, waxing, cutting, sugaring, etc.). In this embodiment, eyebrow region 110 is physically shaped and/or styled in accordance with a client's preferences and in a manner for which a client wishes a cosmetic template to be formed. In some embodiments, eyebrow region 110 has cosmetics applied to eyebrow region 110 in addition to and/or instead of physically shaping and/or styling eyebrow region 110. In this embodiment, the application of cosmetics may include, but is not limited to, brushing, outlining, and filling eyebrow region 110 using a color cosmetic, such as, but not limited to, a wax color, eyeliner, eye shadow, brow shadow, lipstick, and a rub-on tattoo. In this embodiment, the application of cosmetics can be facilitated by one or more cosmetic applicators, including, but not limited to, a brush, a pencil, etc.

FIG. 2 illustrates an embodiment for creating an image of a facial region used to form a customized cosmetic template for eyebrow region 110 of FIG. 1. In FIG. 2, a transfer medium 200 is configured to receive an image of eyebrow region 110. In some embodiments, transfer medium 200 comprises an adhesive characteristic (e.g., glue, cement, etc.) configured to attach, couple, and/or engage transfer medium 200 to a portion of the client's face. For example, in some embodiments, transfer medium 200 may be configured as a tape, a label, a sticker, etc. In some embodiments, transfer medium 200 is partially and/or completely transparent. In some embodiments, transfer medium 200 is configured to span and/or extend across at least a portion or the entire dimension of eyebrow region 110.

In the illustrated embodiment, eyebrow region 110 is physically shaped and/or styled as well as has cosmetics already applied to eyebrow region 110 in accordance with a client's preferences. In FIG. 2, transfer medium 200 is disposed over the entire dimension of eyebrow region 110, thereby encompassing the desired shape, style, cosmetic application, etc. of eyebrow region 110. In the illustrated embodiment, transfer medium 200 comprises surface 210 and surface 220. Surface 210 faces away from eyebrow region 110, and surface 220 is configured to be placed against and/or is facing eyebrow region 110. In FIG. 2, surface 220 comprises an adhesive characteristic enabling transfer medium 200 to couple to a portion of the client's face and/or eyebrow region 110. Furthermore, in FIG. 2, transfer medium 200 is configured to be slightly and/or completely transparent such that eyebrow region 110 is visible on surface 210 when transfer medium 200 is disposed against eyebrow region 110.

In the illustrated embodiment, an imprint 230 of eyebrow region 110 is transferred to surface 220 of transfer medium 200. Imprint 230 is created when surface 220 of transfer medium 200 is coupled to, disposed against, and/or engaged with eyebrow region 110. In some embodiments, pressure is added against surface 210 of transfer medium 200 when transfer medium 200 is coupled to eyebrow region 110 to facilitate the transfer of cosmetics to surface 220 to form imprint 230. Imprint 230 is used to create a customized cosmetic template for a client.

Thus, in operation, cosmetics are applied to eyebrow region 110. In some embodiments, a consultation as to the shape, style, and pattern of eyebrow region 110 is performed prior to the application of cosmetics to eyebrow region 110. Additionally, in some embodiments, eyebrow region 110 is physically shaped and/or styled as well. A user then disposes and/or engages transfer medium 200 over eyebrow region 110 such that transfer medium 200 spans and/or extends across the entire dimension of eyebrow region 110. In some embodiments, pressure (e.g. a user's finger rubbing along the length of eyebrow region 110, etc.) is applied against a surface 210 of transfer medium 200 to facilitate the transfer of cosmetics from the client's face to surface 220 of transfer medium 200 to form imprint 230. Transfer medium 200 is then removed from eyebrow region 110 of the client's face with imprint 230 formed on a surface 220 of transfer medium 200. In some embodiments, transfer medium 200 is then prepared to be transferred to a computing device. For example, in some embodiments, transfer medium 200 is adhesively secured and/or applied to a piece of paper. In some embodiments, an image of the piece of paper with transfer medium 200 disposed thereon is transmitted to a computing device in order to create a customized cosmetic template (e.g., scanned, photographed, electronically mailed, faxed, postal mailed, etc.).

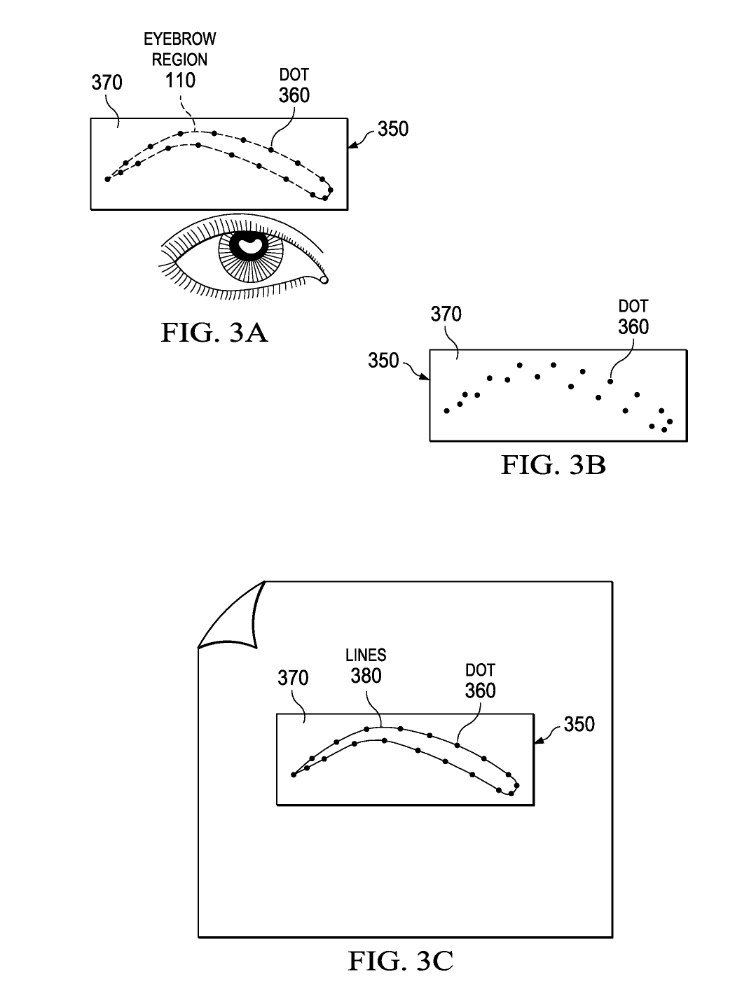

FIGS. 3A through 3C illustrate another embodiment for creating an image of a facial region used to form a customized cosmetic template for the eyebrow region 110 of FIG. 1. In FIGS. 3A through 3C, a transfer medium 350 comprises a surface 370 configured to receive a graphic image from a written instrument (e.g., a pen, marker, pencil, etc.). In other words, transfer medium 350 is configured such that a user can write or mark on surface 370 of transfer medium 350. Furthermore, in FIGS. 3A through 3C, the surface on the opposite side of transfer medium 350 than surface 370 comprises a slightly adhesive characteristic to facilitate the coupling of transfer medium 350 against eyebrow region 110. However, it should be understood that transfer medium may be otherwise adhered to eyebrow region 110 or non-adhesively held in place. Moreover, in some embodiments, transfer medium 350 is configured to be slightly and/or completely transparent such that eyebrow region 110 is visible on surface 370 when transfer medium 350 is disposed against eyebrow region 110.

Referencing FIG. 3A, transfer medium 350 is disposed over the entire dimension of eyebrow region 110. In the illustrated embodiment, a user uses a dotting technique to create the image of eyebrow region 110. In the dotting technique, the user outlines and/or diagrams eyebrow region 110 with a marking device using a series of individual dots (e.g., dots 360). The dots are marked and/or drawn on surface 370 of transfer medium 350. The user can mark and/or draw as many dots as necessary to outline and/or diagram the shape, style, and/or pattern of eyebrow region 110. FIG. 3B illustrates transfer medium 350 after the dotting technique is applied to surface 370 of transfer medium 360. Referencing FIG. 3C, in some embodiments, after the user outlines eyebrow region 110 with dots, the user connect the dots into a series of lines (e.g., lines 380). The series of lines further defines the outline and/or border of eyebrow region 110.

Thus, in operation, in some embodiments, a user shapes and styles eyebrow region 110. In some embodiments, a consultation as to the shape, style, and pattern of eyebrow region 110 is performed prior to the shaping and styling of eyebrow region 110. In some embodiments, cosmetics are applied to eyebrow region 110. A user then disposes and/or engages transfer medium 350 over eyebrow region 110 such that transfer medium 350 spans and/or extends across the entire dimension of eyebrow region 110. The user then marks and/or draws a series of dots 360 on surface 370 of transfer medium 350 to outline and/or dimension eyebrow region 110. Transfer medium 350 is then removed from eyebrow region 110. In some embodiments, the user then connects dots 360 with a series of lines 380 to further define the outline and/or border of eyebrow region 110. In some embodiments, transfer medium 350 is then prepared to be transferred to a computing device. For example, in some embodiments, transfer medium 350 is adhesively secured and/or applied to a piece of paper. In some embodiments, an image of the piece of paper with transfer medium 350 disposed thereon is transmitted to a computing device in order to create a customized cosmetic template (e.g., scanned, photographed, electronically mailed, faxed, postal mailed, etc.).

It should be understood that the embodiments described and illustrated in FIGS. 3A through 3B are used in connection with the embodiment described and illustrated in FIG. 2. Thus, after a user creates an image of eyebrow region 110 using transfer medium 200 of FIG. 2, the user disposes and/or engages transfer medium 350 over region 110 and proceeds with the dotting technique described above. The user can optionally reshape eyebrow region 110 and/or reapply cosmetics to eyebrow region 110 prior to disposing and/or engaging transfer medium 350 to eyebrow region 110. Furthermore, transfer mediums 200 and 350 can be prepared to be transmitted to a computing device together. For example, transfer mediums 200 and 350 can be adhesively secured and/or applied to the same piece of paper, and the image of the paper is transmitted to computing device to create a customized cosmetic template.

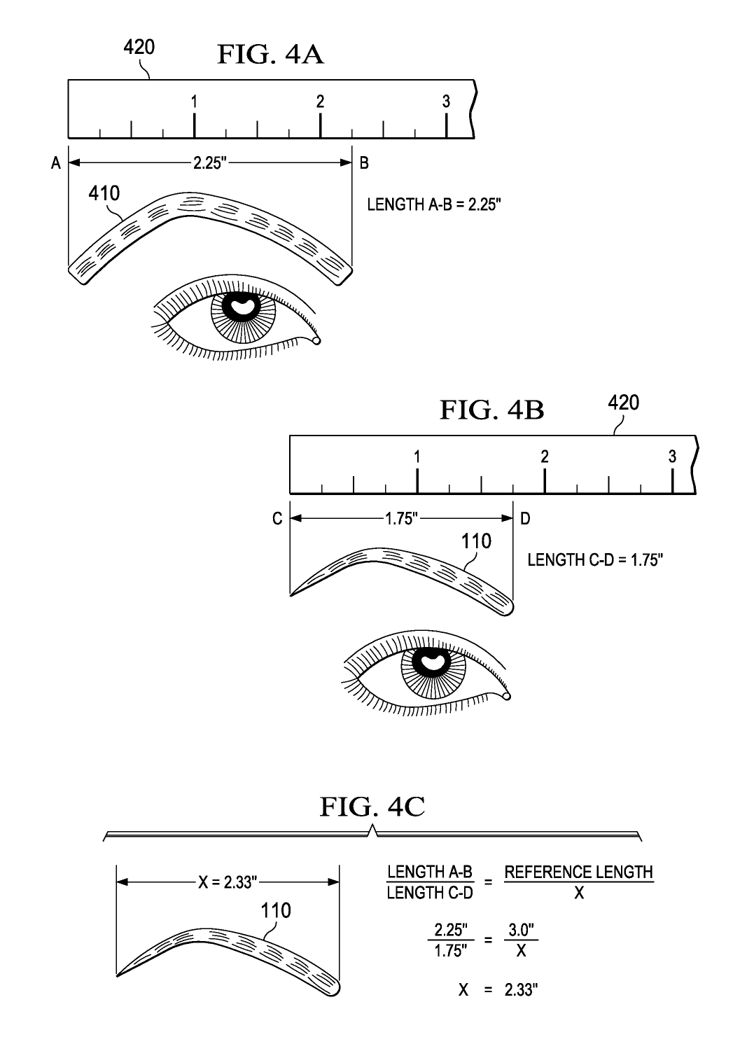

FIGS. 4A through 4C illustrate an embodiment for creating a customized cosmetic template for eyebrow region 110 of FIG. 1. FIGS. 4A through 4C illustrate a method for creating a customized cosmetic template based on a two-dimensional image (e.g., a photograph, etc.) of a client's face. The depth/curvature of each client's face varies; therefore, the actual dimensions of a client's face may not necessarily be accurately reflected in a two-dimensional image. For example, the length of a particular feature of a client's face may be longer when the feature is flattened against a planar surface.

Referencing FIG. 4A, a reference medium 410 is illustrated as being disposed over eyebrow region 110. Reference medium 410 is configured to enable a user to determine the depth (e.g., curvature) of a client's face based on a two-dimensional image of the client's face. Reference medium 410 comprises one or more predetermined, reference dimensions. In FIG. 4A, reference medium 410 is approximately three inches (3″) in length when reference medium 410 is disposed in a planar position (e.g., lying on a flat surface); however, it should be understood that reference medium 410 may be any predetermined, reference dimension.

In FIG. 4A, reference medium 410 is disposed along the curvature of client's face over eyebrow region 110. Thus, reference medium 410 is positioned to follow the shape and curvature of eyebrow region 110. In some embodiments, reference medium 410 comprises an adhesive characteristic (e.g., glue, cement, etc.) configured to attach, couple, and/or engage reference medium 410 to a portion of the client's face. For example, in some embodiments, reference medium 410 may be configured as an adhesive piece of stationary, a tape, a label, a sticker, etc.

In FIG. 4A, a measurement instrument 420 is disposed in a position above reference medium 410 when reference medium 410 is disposed over eyebrow region 110. Measurement instrument 420 is used to measure at least one dimension of reference medium 410 (e.g., length A-B). In the illustrated embodiment, measurement instrument 420 is a ruler; however, it should be understood that measurement instrument 420 can be any other type of measurement instrument (e.g., a measuring tape, etc.).

In FIG. 4A, measurement instrument 420 indicates that the length A-B of reference medium 410 is approximately 2.25″Thus, length A-B is the length of reference medium 410 when the depth/curvature of the client's face is taken into account. Therefore, length A-B is shorter than the actual length of reference medium 410 (e.g., 3″) when reference medium 410 is in a planar position.

FIG. 4B illustrates eyebrow region 110 with measurement instrument 420 disposed above eyebrow region 110. In FIG. 4B, eyebrow region 110 is shaped and/or styled and has cosmetics applied in accordance with a client's preferences. Thus, the shape and/or style of eyebrow region 110 is used to form a customized cosmetic template. In the illustrated embodiment, measurement instrument 420 indicates that the length C-D of eyebrow region 110 is approximately 1.75″Thus, length C-D is the length of eyebrow region 110 when the depth/curvature of the client's face is taken into account.

FIG. 4C illustrates a method for determining a two-dimensional equivalent dimension for the facial region based on the dimensions/measurements illustrated by FIGS. 4A and 4B. The algorithm illustrated by FIG. 4C enables a user to create the boundary(ies) and/or dimension(s) for a customized cosmetic template using a two-dimensional image of the client's face while accounting for the individual depth/curvature of the client's face. FIG. 4C uses the following ratio to determine the appropriate length of customized cosmetic template 430:

$$\frac{Length A \text{-} B}{Length C \text{-} D} = \frac{Reference length}{x} \qquad ( 1 )$$

The reference length is the predetermined, reference dimension of reference medium 410. Thus, in the illustrated embodiment, the reference length of reference medium 410 is three inches (3″). In equation (1), “x” refers to the length of eyebrow region 110 if eyebrow region 110 were disposed in a planar position without consideration of the depth/curvature of the client's face. Thus, “x” is the two-dimensional equivalent dimension for the length C-D and is the length of eyebrow region 110 when formed into a customized cosmetic template.

As indicated above, length A-B in FIG. 4A is 2.25″, and length C-D in FIG. 4B is 1.75″. The reference length is 3″. Therefore, after entering in the aforementioned values into the equation indicated above, “x” is calculated to equal to 2.33″, which is the two-dimensional equivalent length of eyebrow region 110 absent any consideration for depth/curvature.

Thus, in operation, a user/client disposes reference medium 410 over eyebrow region 110 such that reference medium 410 follows the shape/curvature of the client's face. The user/client then disposes measurement instrument 420 above reference medium 410 in order to obtain measurement length A-B. In some embodiments, the user/client records length A-B using a writing instrument and writing pad and/or captures an image of the client's face as illustrated in FIG. 4A in order to record length A-B. The user/client then removes reference medium 410 from eyebrow region 110 and measures length C-D using measurement instrument 420. In some embodiments, the user/client records length C-D using a writing instrument and writing pad and/or captures an image of the client's face as illustrated in FIG. 4B in order to record length A-B.

The user/client then enters the reference length for reference medium 410 and measured lengths A-B and C-D into equation (1) to calculate the value of “x.” The resulting value of “x” is then used to form the length of eyebrow region 110 in customized cosmetic template 430.

It should be understood that a similar method can be employed to calculate other dimensions associated with eyebrow region 110 (e.g., thickness of various portions of eyebrow region 110, the height of the arch relative to the beginning and end of eyebrow region 110). In some embodiments, the other dimensions can also be used to form customized cosmetic template 430.

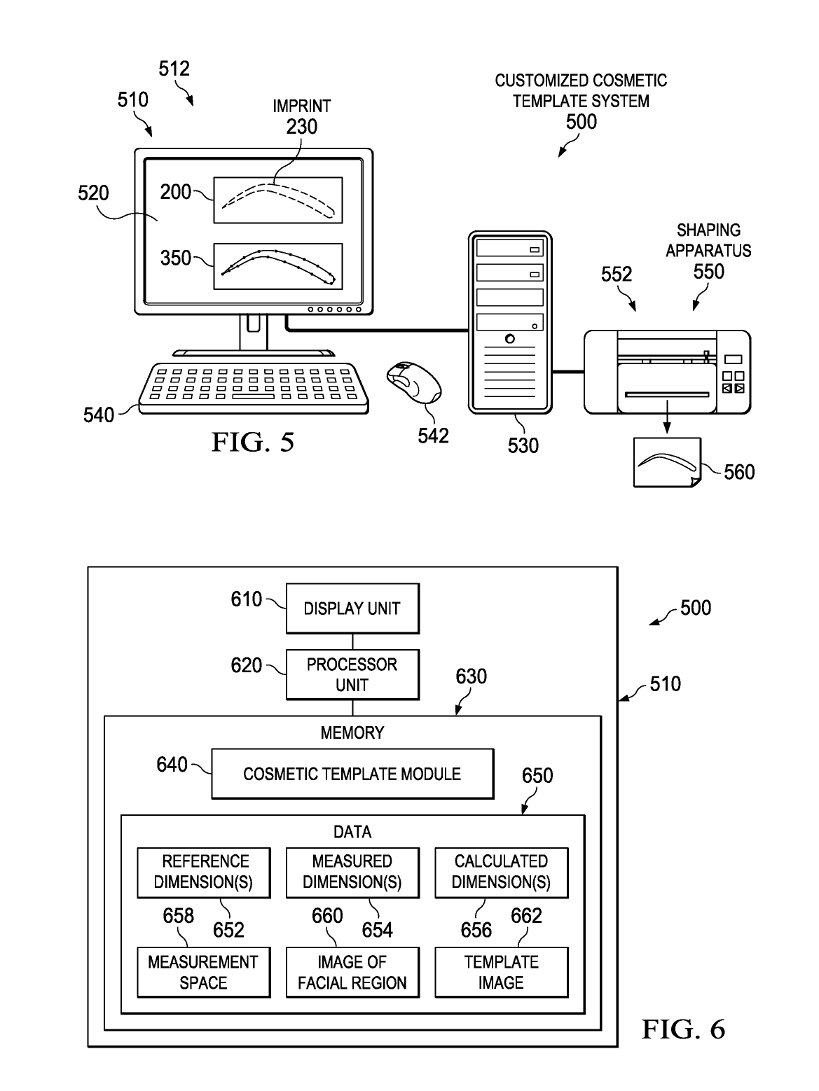

FIG. 5 illustrates an embodiment of a customized cosmetic template system 500. In some embodiments, customized cosmetic template system 500 is configured to receive an image of a facial region for which a customized cosmetic template is to be created. In some embodiments, customized cosmetic template system 500 is configured to receive measured lengths and/or photographs recording lengths of a facial region for which a customized cosmetic template is to be created. Customized cosmetic template system 500 creates the customized cosmetic template based on the received images and/or measured lengths.

In FIG. 5, customized cosmetic template system 500 comprises a computing device 510, a shaping apparatus 550, and a customized cosmetic template 560. In the illustrated embodiment, computing device 510 comprises a desktop computer 512; however, it is understood that computing device 510 may comprise any type of portable or non-portable electronic device, including, but not limited to, a laptop computer, a notebook computer, a tablet computer, a personal digital assistant (PDA), a cellular phone or any other type of portable and/or non-portable electronic device.

In the illustrated embodiment, computing device 510 is configured to receive and/or prepare an image of a facial region for which a customized cosmetic template is to be created. Computing device 510 can receive an image via any method including, but not limited to, scanning and emailing. In some embodiments, computing device 510 is configured to receive an image of imprint 230 on transfer medium 200 and/or an image of the outline of eyebrow region 110 (FIGS. 1, 2, and 3A through 3C) on transfer medium 350. In some embodiments, computing device 510 is configured to receive an image (e.g., a photograph) of a portion and/or complete client's face for which a customized cosmetic template is to be created for a particular facial region (e.g., images illustrated by FIGS. 4A and 4B). In some embodiments, computing device 510 is configured to receive measured lengths in conjunction with an image of a client's face for which a customized cosmetic template is to be created (e.g., measured lengths as illustrated by FIGS. 4A and 4B).

Computing device 510 comprises a display unit 520 coupled to a desktop unit 530, a keyboard 540 and a mouse 542. In the illustrated embodiment, display unit 510 comprises an image of imprint 230 on transfer medium 200 and an image of the outline of eyebrow region 110 on transfer medium 350. In FIG. 5, keyboard 540 and mouse 542 enable a user to edit the images of the facial region (e.g., crop, cut, smooth, merge, add, delete, etc.) and prepare the images to be made into customized cosmetic template 560 by shaping apparatus 550. For example, keyboard 540 and mouse 542 enable a user to edit image of imprint 230 on transfer medium 200 and an image of the outline of eyebrow region 110 on transfer medium 350. In this example, the user can compare the images of transfer medium 200 and transfer medium 350 and subsequently edit the images using keyboard 540 and mouse 542. It should be understood, however, that computer device 510 may comprise other peripheral devices (e.g., a computer pen, a computer brush, etc.) configured to enable a user to edit images presented on display unit 510 of computing device 510. It should also be understood that computing device 510 may use any type of editing application and/or software to enable the user to edit images presented on display unit 510.

In the illustrated embodiment, computing device 510 is coupled to shaping apparatus 550 with a wired cable; however; it should be understood that computing device 510 can also be wirelessly coupled to shaping apparatus 550. Shaping apparatus 550 is a device configured to form, make, and/or create a customized cosmetic template (e.g., customized cosmetic template 560) based on an image transmitted by computing device 510. In some embodiments, shaping apparatus 550 comprises a stamping device 552 configured to stamp and/or cut a cosmetic template from a template medium (e.g., by forming an aperture in the template medium corresponding to the image by, for example, locating an outline or border of the image and forming the aperture based on the location of the outline/border). The template medium can comprise any semi-rigid material including, but not limited to, cardstock, cardboard paper, a plastic resin, vinyl, polyester film, etc. It should be understood, however, that the operation of shaping apparatus 550 can also be performed by the user. For example, instead of using shaping apparatus 550 to cut the template medium, the user can cut the template medium in accordance with a particular image using scissors or any similar device.

Thus, in operation, in some embodiments, computing device 510 receives an image of imprint 230 on transfer medium 200 and an image of an outline of eyebrow region 110 on transfer medium 350. Computing device 510 presents the images on display unit 510. Using keyboard 540 and mouse 542, a user compares the images of transfer medium 200 and transfer medium 350 by manipulating and/or moving the images. In some embodiments, the user overlays the images of the transfer mediums 200 and 350 such that one image is disposed on top of another image. The user can then compare the shape, style, and pattern of imprint 230 on transfer medium 200 against the outline of eyebrow region 110 on transfer medium 350. In some embodiments, the user can either create a new template image and/or edit one of the images on transfer medium 200 or 350 to form the template image. The template image is the image that will be used to create and/or form a customized cosmetic template 560. After the template image is created and/or edited, the user then transfers and/or transmits the template image to be processed by shaping apparatus 550. Shaping apparatus 550 then stamps and/or cuts a template medium such that at least one aperture is created in the template medium to form customized cosmetic template 560 in accordance with the template image.

In some embodiments, in operation, computing device 510 receives one or more photographs of a portion of (e.g., eyebrow region 110) or the entire face of the client. The photograph represents the facial area for which a customized cosmetic template will formed. In some embodiments, the photograph illustrates and/or presents the shape, style, and pattern of the facial region for which the client wishes to create the customized cosmetic template. Thus, in some embodiments, the facial region has already been shaped and/or styled and/or has cosmetics applied to the facial region. In some embodiments, the photographs are used in conjunction with images of transfer mediums 200 and/or 350 in order to edit the images used to form the customized cosmetic template.

In some embodiments, the photographs are used independently to create the customized cosmetic template. In this embodiment, a measurement instrument (e.g., a ruler, tape measure, etc.) is disposed above the facial area for which the customized cosmetic template will be used (e.g., as illustrated by FIGS. 4A and 4B) at the time the photograph is created/captured. In this embodiment, the user reads the measured lengths of a reference length and/or a facial region using the measurement instrument (e.g., as illustrated by FIGS. 4A and 4B). Alternatively, in lieu of photographs, measurements of a reference dimension and dimension(s) of the facial region are submitted by the client/user in conjunction with the photograph (e.g., lengths A-B and C-D of FIGS. 4A and 4B). In this embodiment, a user selects and/or extracts (e.g., cuts, crops, pastes, etc.) the portion of the client's face for which a customized cosmetic template is to be formed. For example, to create customized cosmetic template 560, the user selects and/or extracts eyebrow region 110 from the received photograph. It should be understood that any editing software can be used to extract eyebrow region 110.

In some embodiments, the user then enters in the measured dimensions into equation (1) to calculate the value of “x” indicating the length eyebrow region 110 for customized cosmetic template 560. The user then edits and prepares the extracted image based on the calculated value of “x” and transmits the edited image to shaping apparatus 550. Shaping apparatus 550 then processes the edited image and stamps and/or cuts a template medium such that at least one aperture is created in the template medium to form customized cosmetic template 560 in accordance with the template image.

FIG. 6 is a block diagram of an embodiment of customized cosmetic template system 500 of FIG. 5. In FIG. 6, customized cosmetic template system 500 is configured to create a customized cosmetic template in accordance with the embodiment illustrated by FIGS. 4A through 4C. In some embodiments, customized cosmetic template system 500 is configured to be networked with other computing devices via, for example, the internet.

Customized cosmetic template system 500 comprises computing device 510 having a display unit 610, a processor unit 620, and memory 630. In FIG. 6, memory 630 comprises cosmetic template module 640 and data 650. Cosmetic template module 640 is a set of instructions executable to create a customized template system based on the embodiment illustrated by FIGS. 4A through 4C. Data 650 comprises reference dimension(s) 652, measured dimension(s) 654, calculated dimension(s) 656, measurement space 658, images of facial region 660, and template image 662. Reference dimension(s) 652 is the predetermined, known reference dimension(s) for reference medium 420 (FIG. 4A). In some embodiments, reference dimension(s) 652 comprises a length, a width, and/or thickness dimension. In some embodiments, reference dimension(s) 652 is predetermined and stored in system 500. In some embodiments, reference dimension(s) 652 are entered by a user and/or client at the time data is being entered into customized cosmetic template system 500. Measured dimension(s) 654 is the dimension(s) measured using measurement instrument 420 (FIGS. 4A and 4B). In some embodiments, measured dimension(s) 654 comprises the measured dimensions of reference medium 420 after reference medium 420 is disposed along eyebrow region 110 (FIG. 4A) and/or eyebrow region 110 itself (FIG. 4B). Calculated dimension(s) 656 are the dimension(s) calculated after equation (1) is applied to reference dimension(s) 652 and measured dimension(s) 654.

Measurement space 658 is a boundary area formed based on calculated dimension(s) 656 and which is used to form a customized cosmetic template (e.g., customized cosmetic template 560 of FIG. 5) for a particular facial region (e.g., eyebrow region 110). For example, measurement space 658 creates a boundary area which uses the length “x” as the length for eyebrow region 110. In some embodiments, measurement space 658 may also comprise other measurements used to create the other boundary areas for the customized cosmetic template. In some embodiments, measurement space 658 configured as a work in progress area for which the user/client can form the customized cosmetic template. For example, in some embodiments, measurement space 658 is configured to enable a user to manually dimensionalize (e.g., enlarge, shrink, etc.), shape, smooth, etc. the shape, style, and pattern of the facial region for which the customized cosmetic template is being formed.

Image of facial region 660 comprises one or more images (e.g., photographs, etc.) of the facial region for which the customized cosmetic template is being formed. A user/client uses image of facial region 660 to edit the facial region into the desired style, shape, and/or pattern for the customized cosmetic template. The edited image of facial region 660 is stored as template image 662. Template image 662 is the edited image used to form the customized cosmetic template.

Thus, in operation, cosmetic template module 640 is executed by a user/client via a computing device. In some embodiments, cosmetic template module 640 receives one or images of the facial region uploaded by a user/client for which the customized cosmetic template is to be formed. Cosmetic template module 640 stores the image(s) as image of facial region 660. In some embodiments, the image(s) comprise a measurement instrument 420 (FIGS. 4A and 4B) identifying and/or indicating the measurement of the facial region. In some embodiments, cosmetic template module 640 presents the image(s) to the user so that the user can read one or more dimension(s) presented on the image(s).

In some embodiments, cosmetic template module 640 prompts a user/client to enter in reference dimension(s) 652 for a reference medium. Cosmetic template module 640 then prompts a user/client to enter in measured dimension(s) 654. Cosmetic template module 640 then calculates calculated dimension(s) 656 by applying reference dimension(s) 652 and measured dimension(s) 654 into equation (1) to determine the value of “x.” Based on calculated dimension(s) 656, cosmetic template module 640 determines measurement space 658 and defines the boundary area(s) for a customized cosmetic template. In some embodiments, cosmetic template module 640 presents a work space comprising the defined boundary area(s) for the user to use to edit the facial region.

Cosmetic template module 640 then presents the image(s) stored as image of facial region 660. Cosmetic template module 640 enables the user to cut/crop the facial region for which the customized cosmetic template is being formed and move the cut/cropped image to the work space. Cosmetic template module 640 then enables the user to edit (e.g., add, delete, smooth, etc.) the image and stores the edited image as template image 662. During the editing process, cosmetic template module 640 also enables the user to dimensionalize (e.g., size) the image in accordance with calculated dimension(s) 656. Cosmetic template module 640 then transmits template image 662 to shaping apparatus 550 (FIG. 5) to be formed into customized cosmetic template 560 (FIG. 5). In some embodiments, one or more elements of the present disclosure may be combined and/or otherwise provided as a kit to enable the user to create a cosmetic template (e.g., transfer medium(s), a cosmetic applicator, template medium(s), forming apparatus, etc.).

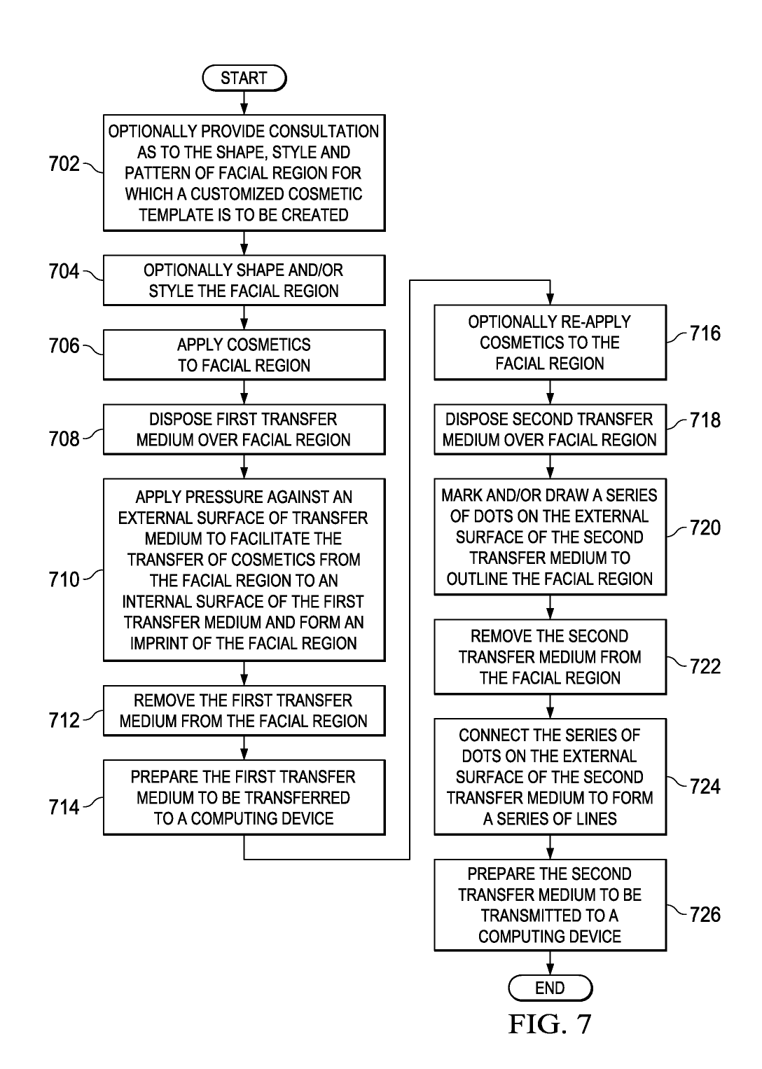

FIG. 7 is a flowchart illustrating an embodiment of a method for creating a customized cosmetic template. The method begins at block 702 with a user providing a consultation as to the shape, style, and pattern of the facial region for which a cosmetic template is to be created. In some embodiments, a facial guide (e.g., facial guide 100 of FIG. 1) is used to identify the reference points to be used for creating and/or designing the shape, style, and/or pattern of the facial region. The user then shapes and/or styles the facial region in accordance with the client's preferences (block 704). Cosmetics are then applied to the facial region (block 706). A transfer medium (e.g., transfer medium 200 of FIG. 2) is then disposed over the facial region for which the cosmetic template is to be created (block 708). Pressure is applied against an outwardly facing surface (e.g., surface 210) of the transfer medium to facilitate the transfer of cosmetics from the facial region to a surface facing the user (e.g., surface 220 of FIG. 2) of the transfer medium and form an imprint (e.g., imprint 230 of FIG. 2) of the facial region (block 710). The transfer medium is removed from the facial region (block 712). The transfer medium is then prepared to be transferred to computing device 510 (block 714). In some embodiments, the transfer medium is adhesively secured to a piece of paper to be subsequently transmitted to computing device 510 (e.g., scanned, photographed, electronically mailed, faxed, postal mailed, etc.).

In some embodiments, a user then re-applies cosmetics to the facial region (block 716). Another transfer medium (e.g., transfer medium 350 of FIGS. 3A through 3C) is then disposed over the facial region for which the customized cosmetic template is to be created (block 718). A series of dots (dots 360 of FIGS. 3A through 3C) are then marked and/or drawn on an outwardly facing surface (e.g., surface 370 of FIGS. 3A through 3C) of the transfer medium to outline and/or dimension the facial region (block 720). The transfer medium is then removed from the facial region (block 722). In some embodiments, the transfer medium is then adhesively secured to a piece of paper. In some embodiments, the series of dots are then connected to form a series of lines (e.g. lines 380 of FIGS. 3A through 3C), thereby further defining an outline and/or border of the facial region (block 724). The transfer medium is then prepared to be transmitted to computing device 510 (block 726), with the method terminating thereafter. However, it should also be understood that the series of dots may be connected using computing device 510 by either user control or automatically by computing device 510.

In some embodiments, the above-referenced transfer mediums are prepared to be transferred to computing device 510 together. In some embodiments, the above-referenced transfer mediums are prepared to be transferred independently to computer device 510. It should be understood that, in some embodiments, the method may terminate at block 714 and the method associated with the latter transfer medium (e.g., blocks 716 through 726) may be absent. It should be understood that, in some embodiments, the method may include blocks 702 through 706 and blocks 718 through 726, with method associated with the former transfer medium (e.g., blocks 708-716) being absent.

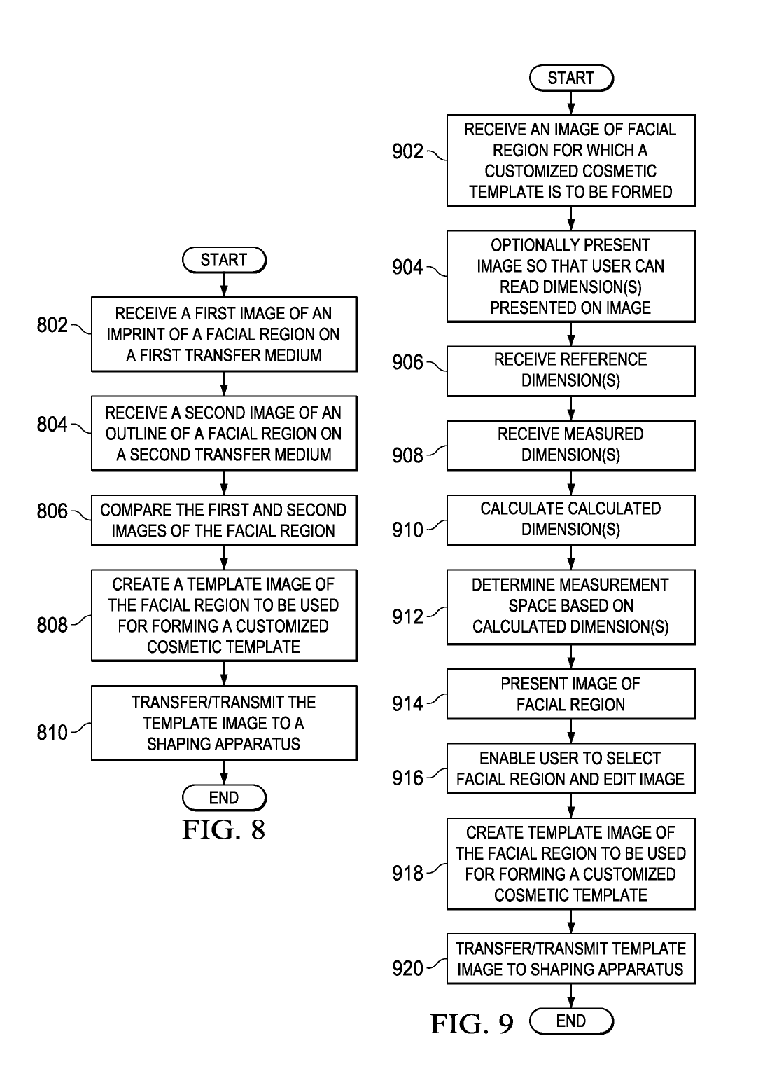

FIG. 8 is a flowchart illustrating another embodiment of a method for creating a customized cosmetic template. The method begins at block 802 with the user receiving a first image of an imprint (e.g., imprint 230 of FIG. 2) of a facial region on a transfer medium (e.g., transfer medium 200 of FIG. 2) via computing device 510 (FIG. 5). The user then receives the second image of an outline of a facial region (e.g., represented by series of dots 360 and/or series of lines 380) on another transfer medium (e.g., transfer medium 350 of FIGS. 3A through 3C) (block 804). The user then compares the first and second images of the facial region (block 806). In some embodiments, the user manipulates and/or moves the images such that the images on the transfer mediums are overlaid or disposed on top of each other. In some embodiments, the user further compares the images to a photographed image of the facial region.

The user then creates a template image of the facial region to be used for forming a customized cosmetic template (block 808). In some embodiments, the user creates a new template image from the two images. In some embodiments, the user edits (e.g., crops, cuts, smoothes, merges, adds, deletes, etc.) one of the images to form the new template image. The template image is the image that will be used to create and/or form the customized cosmetic template. The user then transfers/transmits the template image to shaping apparatus 550 (block 810), with the process terminating thereafter.

FIG. 9 is a flowchart illustrating another embodiment of a method for creating a customized cosmetic template. The method begins at block 902 with the cosmetic template module 640 receiving an image of a facial region for which a customized cosmetic template is to be formed. In some embodiments, cosmetic template module 640 receives one or more images of the facial region which the user/client loads into computing device 510. In some embodiments, each of the images presents a different view and/or perspective of the facial region for which the customized cosmetic template is to be formed. In some embodiments, each of the images comprises a measurement instrument disposed above the facial region for which a customized cosmetic template is to be formed (e.g., as illustrated by FIGS. 4A and 4B).

Cosmetic template module 640 then presents the image(s) so that the user/client can read one or more dimensions presented on the image(s) (block 904). Cosmetic template module 640 then receives reference dimension(s) 652 entered by the user/client and/or reads reference dimension(s) 652 stored by computing device 510 (block 904). Cosmetic template module 640 then receives measured dimension(s) 654 entered by the user/client into computing device 510 (block 908). Cosmetic template module 640 then calculates calculated dimension(s) 656 by applying reference dimension(s) 652 and measured dimension(s) 654 into equation (1) to determine the value of “x” (block 910). Cosmetic template module 640 then determines measurement space 658 based on calculated dimension(s) 654 (block 912).

Cosmetic template module 640 then presents the image(s) stored as image of facial region 660 to the user (block 914) for the user to selects and/or extracts (e.g., cuts, crops, pastes, etc.) the portion of the facial region for which the customized cosmetic template is to be formed (e.g., eyebrow region 110 of FIG. 1) (block 916). The user then creates a template image of the facial region to be used for forming a customized cosmetic template (block 918). In some embodiments, the user edits (e.g., crops, cuts, smoothes, merges, adds, deletes, etc.) the extracted image to form the template image. The user then transfers/transmits the template image to shaping apparatus 550 so that shaping apparatus 550 can stamp and/or cut a template medium to create a customized cosmetic template (e.g., customized cosmetic template 560) (block 920), with the method terminating thereafter.

The illustrative embodiment maybe implemented in software and can be adapted to run on different platforms and operating systems. In particular, functions implemented by customized cosmetic template system 500 for example maybe provided by an ordered listing of executable instructions that can be embodied in any computer readable medium for use by or in connection with an instruction execution system apparatus or device such as a computer based system, processor containing system or other system that can fetch the instructions from the instruction execution system apparatus or device and execute the instructions. In the context of this document a “computer readable medium” can be any means that can contain, store, communicate, propagate, or transport the program for use by or in connection with the instruction execution system apparatus or device. The computer readable medium for example that is not limited to an electronic magnetic optical, electro magnetic infrared or semiconductor system apparatus device or propagation medium. It should be understood that in the described methods, certain functions may be omitted, accomplished in a sequence different from that depicted in FIGS. 7-9, or performed simultaneously. Also, it should be understood that the methods depicted in FIGS. 7-9 may be altered to encompass any of the other features or aspects as described elsewhere in the specification.

Thus, embodiments of customized cosmetic template 560 allow a user to customize a cosmetic template for a particular client. Customized cosmetic template 560 are customized according to the individual features of a client's face (size, shape, etc.). Customized cosmetic template 560 are also customized for a client's preferred style, shape, and/or pattern for the facial area. Embodiments for creating customized cosmetic template 560 can also be applied to any facial area for which a client desires to create a customized cosmetic template.

What is claimed is:

1. A method for creating a customized cosmetic template, comprising:
disposing a transfer medium to a facial region having cosmetics applied thereto;
generating an image from an imprint of the facial region disposed on the transfer medium; and
generating a template of the facial region by forming an aperture in a template medium corresponding to the image.

2. The method of claim 1, further comprising impressing the imprint of the facial region onto the transfer medium by transferring cosmetics applied to the facial region to a surface of the transfer medium.

3. The method of claim 1, further comprising transferring an imprint of an eyebrow region to the transfer medium.

4. The method of claim 3, further comprising diagramming the eyebrow region on a surface of the transfer medium.

5. The method of claim 3, further comprising diagramming the eyebrow region on a surface of the transfer medium by marking an outline of the eyebrow region with dots and connecting the dots into a plurality of lines.

6. The method of claim 1, further comprising editing the image to modify a shape of the facial region.

7. The method of claim 1, further comprising scanning the imprint to form the image of the facial region.

8. A method for creating a customized cosmetic template, comprising:
receiving at least one image of a facial region having cosmetics applied thereto, the facial region identifying an area for which the customized cosmetic template is to be created; and
creating a template image of the at least image to be used by a shaping apparatus to form the customized cosmetic template.

9. The method of claim 8, further comprising selecting the at least one image to be used for the customized cosmetic template.

10. The method of claim 8, wherein the facial region comprises an eyebrow region.

11. The method of claim 8, further comprising receiving at least two images of a facial region represented on a transfer medium.

12. The method of claim 8, wherein the shaping apparatus is configured to cut at least one aperture in a semi-rigid material to form the customized cosmetic template.

13. The method of claim 8, further comprising receiving the at least one image configured to identify at least one dimension of the facial region.

14. The method of claim 8, further comprising determining a two-dimensional equivalent dimension for the facial region based on a ratio which compares a reference dimension against a measured dimension.

15. The method of claim 8, further comprising applying a reference medium to the facial region, the reference medium configured to account for a depth of the facial region in two-dimensional form.

16. The method of claim 8, identifying a measurement space configured to identify a boundary area for the customized cosmetic template.

17. A customized cosmetic template kit, comprising:
a cosmetic template formed by:
shaping an eyebrow region of a client's face;
applying cosmetics to the eyebrow region;
disposing a first transfer medium to the eyebrow region having cosmetics applied such that an imprint of the eyebrow region is transferred to the transfer medium;
responsive to removing the first transfer medium, disposing a second transfer medium to the eyebrow region;
diagramming the eyebrow region on an external surface of the second transfer medium by marking an outline of the eyebrow region with dots and connecting the dots into a plurality of lines; and
transmitting an image of the imprint and an image of the diagrammed eyebrow region to a computing device such that a cosmetic template of the eyebrow region can be formed; and
at least one application device to apply cosmetics to the eyebrow region using the cosmetic template.

18. A cosmetic customization kit, comprising:
at least one apparatus configured to shape and prepare a facial region to receive cosmetics;
at least one cosmetic applicator;
a first transfer medium to apply to the facial region, the at least one transfer medium configured to receive an imprint of the facial region; and
a second transfer medium to apply to the facial region, the second transfer medium configured to receive an outline of the facial regions on an external surface of the second transfer medium.

19. A computer-readable medium having stored thereon on instructions set to be executed, the instruction set, when executed by the processor, causes the processor to:
receiving at least one image of a facial region having cosmetics applied thereto, the facial region identifying an area for which the customized cosmetic template is to be created; and
creating a template image of the at least image to be used by a shaping apparatus to form the customized cosmetic template.

20. The computer-readable medium of claim 19, wherein the instruction set, when executed by the processor, causes the processor to calculate a two-dimensional equivalent dimension for the facial region based on a ratio which compares a reference dimension against a measured dimension.
